(19) United States
(12) Patent Application Publication
(10) Pub. No.: US 2026/0308061 A1
(43) Pub. Date: Oct. 8, 2026

(54) METHOD FOR PRODUCING GEOPOLYMER MATERIAL FROM SILICATE- AND ALUMINATE-RICH WASTE

(71) Applicants: Hau Trung Tran, Bellevue, NE (US); Nghia Trung Tran, Ho Chi Minh City (VN)

(72) Inventors: Hau Trung Tran, Bellevue, NE (US); Nghia Trung Tran, Ho Chi Minh City (VN)

(21) Appl. No.: 19/171,212

(22) Filed: Apr. 5, 2025

(51) Int. Cl. C04B 28/00; C04B 12/00; C04B 18/08; C04B 18/10; C04B 18/14; C04B 18/165; C04B 111/00

(52) U.S. Cl. CPC C04B 28/006; C04B 12/005; C04B 18/08; C04B 18/101; C04B 18/141; C04B 18/165; C04B 2111/00017; C04B 2201/52

(57) ABSTRACT

A method for producing geopolymer materials from silicate- and aluminate-rich wastes is disclosed. The process includes preparing a dry mixture of industrial and/or agricultural waste, adding an alkaline activator, forming a geopolymer slurry, shaping by casting, pressing, extrusion, or pelletizing, and curing at 60° C. to 250° C. The resulting geopolymer exhibits high compressive strength, low permeability, chemical durability, and potential for CO₂ capture and heavy metal immobilization. The product is suitable for use as aggregate, concrete, or precast components in construction and environmental applications.

### TECHNICAL FIELD OF THE INVENTION

The present invention relates to the field of construction materials and waste recycling technologies, specifically to a method for geopolymerizing silicate- and aluminate-rich waste materials in order to convert hazardous waste into sustainable geopolymer concrete.

This method enables the immobilization of heavy metals present in waste by incorporating them into the crystalline structure of the geopolymer, thereby minimizing the risk of environmental leaching. Concurrently, it produces a construction material capable of CO₂ absorption, chemical corrosion resistance, and withstanding harsh conditions in marine environments or in industrial and civil infrastructure requiring high durability and environmental safety.

The invention also enables broad applications in the production of construction aggregates, precast concrete products, and radiation-shielding materials, contributing to sustainable construction and the reduction of greenhouse gas emissions.

### BACKGROUND OF THE INVENTION

Industries such as waste-to-energy (WTE) incineration, metallurgy, coal-fired power generation, cement production, mining, and agro-processing generate large volumes of solid waste containing silicate and aluminate components. Representative waste materials include:
Fly ash from waste incineration: Including incinerator fly ash (IFA) and bottom ash (IBA) from flue gas treatment systems and combustion chambers.
Biomass power plant ash: Derived from burning rice husks, wood chips, or agricultural residues.
Coal-fired power plant fly ash: Produced from burning coal, peat, or fossil fuels.
Metallurgical slags and cement kiln dust: Generated from blast furnaces, rotary kilns, or clinker production.
Rice husk ash: From combustion processes in rice mills or industrial furnaces.

Although these wastes are rich in silica (SiO₂) and alumina (Al₂O₃)—key precursors for geopolymerization—they also contain toxic heavy metals such as lead (Pb), mercury (Hg), cadmium (Cd), zinc (Zn), copper (Cu), chromium (Cr), and arsenic (As), posing significant risks to human health and the environment if improperly handled.

Conventional treatment methods such as cement solidification, vitrification, sanitary landfilling, or chemical extraction suffer from drawbacks including high treatment costs, limited heavy metal immobilization stability, or the generation of secondary waste.

Geopolymerization has emerged as a sustainable technological solution capable of effectively immobilizing heavy metals within a three-dimensional aluminosilicate network while simultaneously producing high-performance construction materials. The geopolymer reaction mineralizes hazardous substances into chemically and physically stable structures, reducing environmental release and supporting circular economy goals and greenhouse gas emission reductions.

In recent years, geopolymer technology has emerged as a promising sustainable alternative to Portland cement, capable of utilizing industrial and agricultural wastes while significantly reducing carbon emissions. However, most conventional geopolymer processes are limited to a specific type of waste or require narrowly defined processing conditions, which restricts their adaptability and scalability in diverse real-world applications.

Several prior inventions have addressed geopolymer production using industrial waste:
U.S. Pat. No. 8,562,735B2 (Allouche et al.) discloses a method for producing geopolymer concrete from incinerator fly ash and coal fly ash, activated by a solution of NaOH and sodium silicate. While this approach effectively immobilizes heavy metals from municipal waste, it is limited exclusively to industrial fly ashes and does not consider the use of agricultural residues as silica sources.
U.S. Pat. No. 9,120,701B2 (Amritphale et al.) describes a hybrid organic-inorganic geopolymer formed from raw rice huskand fly ash, without pre-burning the biomass or adding external sodium silicate. This method focuses on mechanochemical treatment and the in-situ generation of soluble silicates, resulting in a hybrid geopolymeric matrix containing residual organic matter. It does not involve calcined agricultural ashes or the production of fully inorganic geopolymer binders.

In contrast to Allouche's method, which is restricted to industrial fly ash, the present invention flexibly incorporates agricultural ashes, such as rice husk ash and biomass ash, as supplementary sources of SiO₂ in the geopolymer mix. Additionally, it utilizes red mud or finely ground bauxite ore to increase Al₂O₃ content, allowing for a tunable SiO₂/Al₂O₃ molar ratio and broader raw material compatibility. This approach enhances the geopolymerization reaction and provides improved control over mechanical and environmental performance.

Furthermore, a distinctive technical feature of the present invention is the application of elevated curing temperatures up to 250° C., significantly exceeding the common 60-90° C. range used in prior geopolymer processes. This extended temperature range accelerates hardening, improves final strength, and supports diverse forming techniques such as casting, pressing, extrusion, pelletization, or even 3D printing. The ability to cure at high temperatures enables the production of high-performance components suitable for load-bearing structures, marine applications, and radiation shielding—use cases rarely addressed in earlier patents.

### SUMMARY OF THE INVENTION

The present invention discloses a method for geopolymerizing silicate- and aluminate-rich waste by combining such waste with supplemental materials rich in SiO₂ and Al₂O₃ (e.g., crushed sand, glass powder, aluminum powder, rice husk ash, metakaolin, red mud, finely ground bauxite ore, basalt or granite dust), followed by activation using an alkaline solution to form a geopolymer slurry, which is then molded into geopolymer material.

The process includes the following steps:
1. Material Preparation, comprising:
   a. Waste materials rich in silicates and aluminates: 30% to 99% by dry weight;
   b. Alkaline activator: 1% to 10% by dry weight;
   c. Supplemental materials rich in SiO₂ and Al₂O₃: comprising the remainder of the dry mix;
   d. Water: 5% to 60% by total weight of the geopolymer mix;
      i. For shaping methods such as pressing, extrusion, rolling, centrifugal casting, or pelletizing: 5% to 25%;
      ii. For casting methods: up to 60%.
2. Preparation of Alkaline Activator Solution by dissolving the alkaline substance in water.
3. Mixing the Activator Solution with the dry materials to form a geopolymer slurry.
4. Shaping the Slurry using techniques such as casting, pressing, extrusion, rolling, centrifugal casting, vibration, or vibro-compaction.
5. Curing by Drying at 60° C. to 250° C. to complete the geopolymerization process.

### Preferred Embodiments

Waste sources may include: fly ash (from incineration or coal combustion), metallurgical slag, cement kiln dust, rice husk ash, fired clay, biomass ash, ceramic/glass waste, mining sludge, or peat ash.
Supplemental materials include: crushed sand, glass powder, aluminum powder, fine rice husk ash, metakaolin, red mud, finely ground bauxite ore, basalt or granite powder.
Alkaline activators may include: NaOH, KOH, Na₂SiO₃, K₂SiO₃, or combinations thereof.
Waste materials may be used individually or blended to optimize the SiO₂/Al₂O₃ molar ratio in the geopolymer mix.
The geopolymer slurry may be pre-compacted into pellets for better density and shaping compatibility with industrial forming techniques.
The molar ratio of SiO₂ to Al₂O₃ is adjusted between 1.5 and 5 to optimize geopolymerization.
Additives such as pozzolans, plasticizers, waterproofing agents, strength enhancers, or reinforcing fibers may be included.
The slurry may be preheated to 60° C.-150° C. prior to shaping to accelerate setting.
Drying can be performed using electric, gas, infrared, vacuum, autoclave, microwave, solar, or hybrid systems.
The resulting geopolymer material may absorb and retain CO₂, improving mechanical strength and reducing greenhouse gas emissions.
Products exhibit chemical corrosion resistance and are suitable for civil, industrial, and marine structures.
Up to 15% barium sulfate (BaSO₄) may be added to enhance radiation shielding for applications in nuclear plants, hospitals, or labs.
The geopolymer product can replace traditional aggregates in Portland cement concrete.
The products manufactured by this method are compatible with applications currently served by Portland cement concrete.

### DETAILED DESCRIPTION OF THE INVENTION

The process for manufacturing geopolymer concrete according to this invention includes the following main steps:

### Step 1: Material Preparation

The dry input mixture consists of:
(a) Silicate- and aluminate-rich waste materials: 30% to 99% by dry weight, selected from:
   Fly ash from incineration (IFA, IBA);
   Fly ash from coal-fired power plants;
   Metallurgical slags (e.g., blast furnace slag, steel slag);
   Cement kiln dust;
   Rice husk ash and biomass ash;
   Fired clay;
   Ceramic and glass industry waste;
   Mining sludge;
   Peat ash.
(b) Alkaline activators: 1% to 10% by dry weight, selected from:
   Sodium hydroxide (NaOH);
   Potassium hydroxide (KOH);
   Sodium silicate (Na₂SiO₃);
   Potassium silicate (K₂SiO₃);
   Or mixtures thereof.
(c) Supplemental materials rich in SiO₂ and Al₂O₃: making up the remainder of the dry mix, selected from:
   Crushed sand;
   Glass powder;
   Aluminum powder;
   Fine rice husk ash;
   Metakaolin;
   Red mud;
   Finely ground bauxite ore;
   Basalt or granite powder.
(d) Water: Added at 5% to 60% of total geopolymer mixture weight.
   For shaping by pressing, extrusion, rolling, centrifugal casting, or pelletizing: 5% to 25%;
   For casting: up to 60% for adequate flowability.

### Technical Note:

Supplemental materials may be used individually or blended to adjust the SiO₂/Al₂O₃ molar ratio between 1.5 and 5, optimizing the geopolymerization reaction.

### Step 2: Preparation of Alkaline Activator Solution

The alkaline substance is dissolved in water to form a homogeneous activator solution, which may be used at room temperature or slightly heated (not exceeding 60° C.) to enhance reactivity with active minerals.

### Step 3: Mixing to Form Geopolymer Slurry

The alkaline activator solution is mixed with the dry blend (waste+supplemental materials) to form a geopolymer slurry.

Optional Additives:
Pozzolanic materials (e.g., silica fume, ground granulated blast furnace slag);
Superplasticizers;
Waterproofing agents;
Strength enhancers or structural stabilizers;
Reinforcing fibers (e.g., glass, polypropylene, basalt, steel) to improve flexural strength and crack resistance.

### Optional Preheating:

The slurry may be preheated to 60° C.-150° C. before shaping to accelerate initial geopolymerization.

### Step 4: Shaping

The slurry or pre-compacted pellets may be shaped using one or a combination of the following industrial methods:
Casting;
Pressing or vibro-compaction;
Extrusion;
Rolling;
Centrifugal casting;
Pelletizing (especially for aggregates or precast components).

Preferred Technique:
The slurry may be pelletized prior to shaping to enhance density, geometric control, and process compatibility.

### Step 5: Drying and Hardening

The shaped product is dried at temperatures between 60° C. and 250° C. to complete the geopolymerization process.

Depending on the product requirements, raw material type, and facility capabilities, drying may be performed using:
Electric furnaces;
Gas kilns;
Infrared dryers;
Vacuum chambers;
Autoclaves;
Industrial microwave dryers;
Solar energy drying systems;
Or combinations thereof.

Drying duration may range from 5 minutes to 24 hours, depending on product size, initial moisture content, and process parameters.

### Material Characteristics of the Resulting Product

The resulting geopolymer material exhibits several outstanding properties:
CO₂ absorption and retention: The aluminosilicate network formed during geopolymerization enables the material to absorb and store CO₂, enhancing mechanical strength and reducing greenhouse gas emissions.
Chemical corrosion resistance: Particularly effective in environments with chloride (Cl⁻), sulfate (SO₄²⁻), marine exposure, wastewater treatment structures, and chemical plants.
Thermal and fire resistance: Suitable for structural applications requiring high heat resistance.
Optional radiation shielding: The addition of up to 15% Barium Sulfate (BaSO₄) enhances ionizing radiation shielding, making it suitable for:
   Nuclear facilities;
   Radiology rooms, CT-scan facilities;
   Nuclear physics laboratories.

Geopolymer products made using this method can serve as functional and structural equivalents to Portland cement-based concrete products, including but not limited to:
Non-fired bricks, roofing tiles;
Pavement bricks, concrete blocks;
Precast components such as beams, floor panels, tanks, and culverts;
In-situ structural elements such as beams, slabs, and columns in civil and industrial works;
Offshore and coastal protection structures such as tetrapods, dolos, and wave-dissipating concrete blocks;
High-durability applications including 3D printed geopolymer infrastructure.

Although geopolymer concrete differs chemically from Portland cement concrete, the final products can meet or exceed technical performance requirements depending on mix design and curing conditions.

### Examples

### Example 1: Geopolymer Aggregate from Incinerator Fly Ash, Red Mud, and Crushed Sand

Dry mix composition:
Incinerator fly ash: 60%
Red mud: 20%
Crushed sand: 10%
Alkaline activator: 10% (4% NaOH, 6% Na₂SiO₃)
Water: 18% (by total mix weight)

### Process:

1. Prepare the alkaline solution by dissolving NaOH and Na₂SiO₃ in water.
2. Mix dry components and activator solution in a planetary mixer.
3. Pelletize using a disc pelletizer.
4. Dry pellets at 100° C. for 12 hours using a resistive oven.

Results:
7-day compressive strength: 48 MPa
Water absorption: 6.2%
No detectable heavy metal leaching (TCLP-EPA 1311)

### Example 2: Pavement Bricks from Metallurgical Slag and Metakaolin

Dry mix composition:
Ground blast furnace slag: 55%
Metakaolin: 25%
Glass powder: 10%
Alkaline activator: 10% (5% KOH, 5% K₂SiO₃),
Water: 14%

### Process:

1. Prepare alkaline solution and cool to ~40° C.
2. Mix dry and liquid components for 10 minutes.
3. Shape using vibro-compaction mold.
4. Preheat at 80° C. for 2 hours.
5. Dry at 120° C. for 8 hours in an infrared oven.

Results:
Compressive strength: 7.1 MPa
Abrasion loss: 0.5 g/cm²
Surface durability under weather and pedestrian traffic; meets pavement brick standards.

### Example 3: Wall Block from Rice Husk Ash and Fired Clay

Composition:
Rice husk ash (high SiO₂): 50%
Finely ground fired clay: 30%
Aluminum powder (gas-forming agent): 2%
Red mud: 8%
NaOH: 5%
Water: 20%
Superplasticizer: 0.3%

### Process:

1. Mix dry components with pre-prepared NaOH solution.
2. Cast into 400×200×200 mm block molds.
3. Air-dry for 24 hours, followed by 4 hours in a 600W industrial microwave.

Results:
Lightweight (density ~1550 kg/m³), compressive strength: 11 MPa.
Good thermal insulation and CO₂ absorption after 28 days.

### Example 4: Radiation-Shielding Aggregate from Fly Ash and BaSO₄

Composition:
Incinerator fly ash: 65%
Basalt powder: 10%
Barium sulfate (BaSO₄): 15%
Sodium silicate (Na₂SiO₃): 10%
Water: 12%

### Process:

1. Mix dry components and Na₂SiO₃ solution.
2. Pelletize into 10-20 mm aggregates using centrifugal press.
3. Dry at 150° C. for 10 hours.

Results:
Compressive strength: 42 MPa
Density: 2.6 g/cm³
40% reduction in gamma radiation compared to regular aggregates.

### Example 5: Marine Protection Tetrapod Using Biomass Ash and Ground Bauxite

Composition:
Biomass ash: 40%
Finely ground bauxite ore: 35%
Crushed granite: 15%
NaOH: 5%
K₂SiO₃: 5%
Water: 18%

### Process:

1. Prepare NaOH—K₂SiO₃ alkaline solution.
2. Wet-mix all components in a forced mixer.
3. Cast into 2-ton tetrapod mold.
4. Cure for 3 days in a controlled humidity room.
5. Dry at 60° C. for 3 more days in an industrial autoclave.

Results:
Compressive strength: 65 MPa
High resistance to Cl⁻ and SO₄²⁻ ion penetration
Withstood 1000 wet-dry salt exposure cycles without failure.

### TECHNICAL BENEFITS AND APPLICATIONS

### Technical Advantages

1. Heavy metal immobilization: Geopolymerization creates a stable aluminosilicate crystalline structure that immobilizes hazardous metals (Pb, Hg, Cd, Cr, Zn, Cu, As) over long-term environmental exposure.
2. CO₂ sequestration: Some geopolymer structures can absorb CO₂ from the atmosphere or surroundings, reducing greenhouse gas emissions and improving chemical durability.
3. Chemical resistance: Excellent resistance to aggressive environments such as seawater, acids, light alkalis, Cl⁻ and SO₄²⁻ ions—ideal for coastal, sewer, chemical, and wastewater structures.
4. High strength and thermal stability: Achievable compressive strength>40 MPa, heat resistance up to 600-900° C.—superior to conventional cement concrete.
5. Radiation shielding capability: With up to 15% BaSO₄, the material blocks gamma and X-rays—suitable for radiation facilities, X-ray rooms, and nuclear plants.
6. Feedstock flexibility: The method allows diverse industrial and agricultural waste inputs, with tunable SiO₂/Al₂O₃ ratios to optimize geopolymerization reactions.

### Practical Applications

Resulting geopolymer products can fulfill equivalent structural and functional roles as Portland cement concrete, including:
1. Non-structural building materials:
   a. Non-fired bricks, blocks, pavers, lightweight concrete;
   b. Roofing tiles, wall panels.
2. Precast elements:
   a. Beams, floor panels, columns, lintels, stairs, tanks, drainage units.
3. In-situ construction:
   a. Structural elements for civil/industrial buildings (beams, slabs, columns);
   b. Foundations or corrosion/heat-resistant walls.
4. Offshore and marine works:
   a. Tetrapods, dolos, wave breakers, coastal defense blocks;
   b. Marine piers, sand dikes, sea barriers.
5. Specialized infrastructure:
   a. X-ray rooms, surgical theaters, CT-scan zones, radioactive storage;
   b. Nuclear plants, radiation shielding walls.
6. 3D printed and modular structures:
   a. Large-scale 3D printed elements for lightweight infrastructure;
   b. Modular housing, power stations, pedestrian bridges, security checkpoints.

1. A method for producing a geopolymer material from silicate- and aluminate-rich waste materials, the method comprising:
(a) preparing a dry mixture comprising:
(i) from 30% to 99% by dry weight of silicate- and aluminate-rich waste materials;
(ii) from 1% to 10% by dry weight of an alkaline activator; and
(iii) the remainder of the dry mixture comprising supplemental materials rich in silica (SiO₂) and alumina (Al₂O₃);
(b) adding from 5% to 60% water by total weight of the geopolymer mixture, wherein:
(i) for shaping by pressing, extrusion, rolling, centrifugal casting, or pelletizing, the water content ranges from 5% to 25%; and
(ii) for shaping by casting, the water content is up to 60%;
(c) dissolving the alkaline activator in water to form an alkaline activator solution;
(d) blending the alkaline activator solution with the dry mixture to form a geopolymer slurry;
(e) shaping the geopolymer slurry using at least one method selected from the group consisting of casting, pressing, extrusion, rolling, centrifugal casting, vibration, and vibro-compaction; and
(f) curing the shaped material by drying at a temperature ranging from 60° C. to 250° C. to complete geopolymerization.

2. The method of claim 1, wherein the waste materials are selected from the group consisting of: incinerator fly ash, coal fly ash, metallurgical slag, cement kiln dust, rice husk ash, fired clay, biomass ash, ceramic waste, glass waste, mining sludge, and peat ash.

3. The method of claim 1, wherein supplemental materials are selected from: crushed sand, glass powder, aluminum powder, rice husk ash, metakaolin, red mud, finely ground bauxite ore, basalt dust, and granite powder.

4. The method of claim 1, wherein the alkaline activator comprises NaOH, KOH, Na₂SiO₃, K₂SiO₃, or combinations thereof.

5. The method of claim 1, wherein the waste may be used singly or in blends to optimize the SiO₂/Al₂O₃ molar ratio.

6. The method of claim 1, wherein the slurry is pre-compacted into pellets prior to shaping to improve density and formability.

7. The method of claim 1, wherein the SiO₂/Al₂O₃ molar ratio is adjusted between 1.5 and 5 for optimal geopolymerization.

8. The method of claim 1, further comprising adding additives selected from pozzolans, plasticizers, waterproofing agents, strength enhancers, and reinforcing fibers.

9. The method of claim 1, wherein the slurry is preheated to 60° C.-150° C. before shaping.

10. The method of claim 1, wherein drying is conducted using electric, gas, infrared, vacuum, autoclave, microwave, solar, or hybrid systems.

11. The method of claim 1, wherein the resulting geopolymer material absorbs and retains CO₂, enhancing strength and lowering emissions.

12. The method of claim 1, wherein the product is chemically resistant and suitable for marine, civil, and industrial applications.

13. The method of claim 1, wherein up to 15% BaSO₄ is added to enhance radiation shielding for nuclear plants, hospitals, and laboratories.

14. The method of claim 1, wherein the geopolymer product replaces conventional aggregate in Portland cement concrete.

15. The method according to any one of claims 1 to 14, wherein the final product exhibits properties and functionalities comparable to those of conventional Portland cement concrete.
